(19) United States
(12) Patent Application Publication
(10) Pub. No.: US 2022/0186843 A1
(43) Pub. Date: Jun. 16, 2022

(54) DISCHARGE VALVES, PRESSURE VESSEL ASSEMBLIES HAVING DISCHARGE VALVES, AND METHODS OF MAKING DISCHARGE VALVES

(71) Applicant: Carrier Corporation, Palm Beach Gardens, FL (US)

(72) Inventor: Thomas Carl Kjellman, Uxbridge, MA (US)

(21) Appl. No.: 15/734,158

(22) PCT Filed: Aug. 3, 2020
(86) PCT No.: PCT/US2020/044739

§ 371 Date: Dec. 1, 2020

Related U.S. Application Data
(60) Provisional application No. 62/892,259, filed on Aug. 27, 2019.

(51) Int. Cl. F16K 7/10; A62C 13/64; A62C 13/76

(52) U.S. Cl. CPC F16K 7/10; A62C 13/76; A62C 13/64

(57) ABSTRACT

A discharge valve includes a valve body, a closure, and a non-rigid valve member. The valve body has a bore that extends between an inlet and an outlet. The closure is seated to the valve body and extends to the bore. The non-rigid valve member has an interior and is fixed within the bore between the inlet and the outlet of the valve, the interior of the non-rigid valve member in fluid communication with the closure for expansion and contraction of the non-rigid valve member. Fire extinguisher assemblies and methods of making fire extinguisher assemblies are also described.

### CROSS REFERENCE TO RELATED APPLICATIONS

This application claims the benefit of U.S. Application No. 62/892,259, filed on Aug. 27, 2019, which is incorporated herein by reference in its entirety.

### BACKGROUND

The present disclosure relates generally to fluid systems, and more particularly to controlling flow through discharge valves in fluid systems, such as from pressure vessels.

Discharge valves, such as in fire extinguishers, commonly employ a rigid plunger or poppet movable between an open position and a closed position relative to a valve structure. In the closed position the plunger or poppet retains a fluid, e.g., an expellant and a suppressant within a storage vessel. Upon actuation the plunger or poppet moves to the open position, the expellant and suppressant thereby flowing around the rigid plunger or poppet and issuing from the valve structure. Actuation generally requires application of force enough to overcome the force of the expellant within the storage vessel such that the rigid plunger or poppet moves from the closed position to the open position.

In some discharge valves the valve structure and the plunger or poppet can require relatively tight tolerances. The relatively tight tolerances of the valve structure and the rigid plunger or poppet generally operate to limit leakage of the expellant and/or the suppressant through the discharge valve, the expellant and suppressant thereby available for extended periods of time prior to actuation of the discharge valve. The relatively tight tolerances also enable smooth movement of the plunger or poppet within the valve structure upon actuation.

Such systems and methods have generally been suitable for their intended purpose. However, there remains a need in the art for improved valves, pressure vessel assemblies, and methods of making discharge valves and pressure vessel assemblies. The present disclosure provides a solution to this need.

### BRIEF DESCRIPTION

A discharge valve is provided. The discharge value includes a valve body with a bore extending between an inlet and an outlet, a closure seated to the valve body and extending to the bore, and a non-rigid valve member. The non-rigid valve member has an interior and is fixed within the bore between the inlet and the outlet of the valve body. The interior of the non-rigid valve member is in fluid communication with the closure for expansion and contraction of the non-rigid valve member.

In addition to one or more of the features described above, or as an alternative, further embodiments of the discharge valve may include that the bore has an inlet segment and an outlet segment, the inlet segment of the bore joining the outlet segment of the bore at an intersection within the valve body.

In addition to one or more of the features described above, or as an alternative, further embodiments of the discharge valve may include that the outlet segment of the bore is orthogonal relative to the inlet segment of the bore.

In addition to one or more of the features described above, or as an alternative, further embodiments of the discharge valve may include that the outlet segment of the bore is oblique relative to the inlet segment of the bore.

In addition to one or more of the features described above, or as an alternative, further embodiments of the discharge valve may include that the outlet segment of the bore is coaxial relative to the inlet segment of the bore.

In addition to one or more of the features described above, or as an alternative, further embodiments of the discharge valve may include that the closure extends in parallel with the outlet segment of the bore, wherein the closure is orthogonal or oblique relative to the inlet segment of the bore.

In addition to one or more of the features described above, or as an alternative, further embodiments of the discharge valve may include that the non-rigid valve member is formed from an elastomeric material.

In addition to one or more of the features described above, or as an alternative, further embodiments of the discharge valve may include that the non-rigid valve member has a fixed end and a free end, the fixed end fixed to an interior surface of the bore by the closure, the free end arranged between the closure and the outlet of the bore.

In addition to one or more of the features described above, or as an alternative, further embodiments of the discharge valve may include that the valve body defines a channel extending between an exterior surface of the valve body and an interior surface of the bore.

In addition to one or more of the features described above, or as an alternative, further embodiments of the discharge valve may include that the closure has a tube member with a threaded portion and a longitudinally opposite flange portion, the flange portion compressing a portion of the valve member against an interior surface of the bore, the threaded portion extending beyond an exterior surface of the valve body and receiving thereon a seal element.

In addition to one or more of the features described above, or as an alternative, further embodiments of the discharge valve may include that the closure includes a frangible member, a manually-actuated valve, or an electrically actuated valve.

In addition to one or more of the features described above, or as an alternative, further embodiments of the discharge valve may include an inflation gas impounded within the non-rigid valve member.

In addition to one or more of the features described above, or as an alternative, further embodiments of the discharge valve may include that the non-rigid valve member has first volume and a second volume, the first volume greater than the second volume, the first volume occluding the bore and fluidly separating the inlet from the outlet of the valve body, the second volume not occluding the bore, the inlet in fluid communication with the outlet of the valve body.

A fire extinguisher assembly is also provided. The fire extinguisher assembly includes a pressure vessel with a boss, a discharge valve as described above, and a fire suppressant. The pressure vessel has a chamber and the boss defines a port in communication with the chamber. The discharge valve is fixed to the boss, the inlet of the valve body being in fluid communication with the chamber through the port defined by the boss. The fire suppressant is contained within the chamber of the pressure vessel and the non-rigid valve member occludes the bore such that fire suppressant is retained within the chamber.

In addition to one or more of the features described above, or as an alternative, further embodiments of the fire extinguisher may include that the valve body defines a channel extending between an exterior surface of the valve body and an interior surface of the bore, and that the closure includes a tube member having a threaded portion and a longitudinally opposite flange portion, the flange portion compressing a portion of the valve member against an interior surface of the bore, the threaded portion extending beyond an exterior surface of the valve body and receiving thereon a seal element.

In addition to one or more of the features described above, or as an alternative, further embodiments of the fire extinguisher may include an inflation gas including air impounded within the non-rigid valve member.

In addition to one or more of the features described above, or as an alternative, further embodiments of the fire extinguisher may include an inert inflation gas impounded within the non-rigid valve member.

In addition to one or more of the features described above, or as an alternative, further embodiments of the fire extinguisher may include an inflation gas impounded within the non-rigid valve member, the inflation gas including additional fire suppressant.

A method of making a discharge valve is additionally provided. The method includes defining a bore extending between an inlet and an outlet in a valve body and seating a closure within the valve body such that the closure extends at least partially within the bore. A non-rigid valve member with an interior is then fixed within the bore between the inlet of the valve body and the outlet of the valve body, wherein the seating the closure to the valve body further includes placing the interior of non-rigid valve member in fluid communication with the closure.

Technical effects of the present disclosure include discharge valves which can tolerate loose dimensional tolerances within the valve body relative to discharge valves employing rigid valve members while providing similar (or equivalent) reliability. Technical effects of discharge valves constructed in accordance with the present disclosure also compactness, certain embodiments of discharge valves of the present disclosure having relatively small size relative to flow area in comparison to discharge valves employing rigid valve members.

### BRIEF DESCRIPTION OF THE DRAWINGS

The following descriptions should not be considered limiting in any way. With reference to the accompanying drawings, like elements are numbered alike:

FIG. 1 is a schematic view of a pressure vessel assembly in accordance with the present disclosure, showing a fire extinguisher assembly having discharge valve with a non-rigid valve member seated within a boss of a pressure vessel;

FIG. 2 is an exploded view of the valve of FIG. 1 according to an embodiment, showing the non-rigid valve member and the closure exploded away from the valve body, the valve body having a bore with an inlet segment that is substantially orthogonal relative to an outlet segment;

FIGS. 3 and 4 are schematic views of the valve of FIG. 1 according to further embodiments, showing bores of the valve bodies having outlet segments that are oblique and coaxial to inlet segments, respectively;

FIGS. 5 and 6 are schematic views of the valve of FIG. 1, showing the non-rigid valve member having a first volume and a second volume, the first volume fluidly separating a compressed fluid disposed within the pressure vessel from the external environment, the second volume allowing fluid communication between the chamber and the external environment through the discharge valve; and

FIG. 7 is a block diagram of a method of making a pressure vessel assembly, showing steps of the method according to an illustrative and non-limiting embodiment of the method.

### DETAILED DESCRIPTION

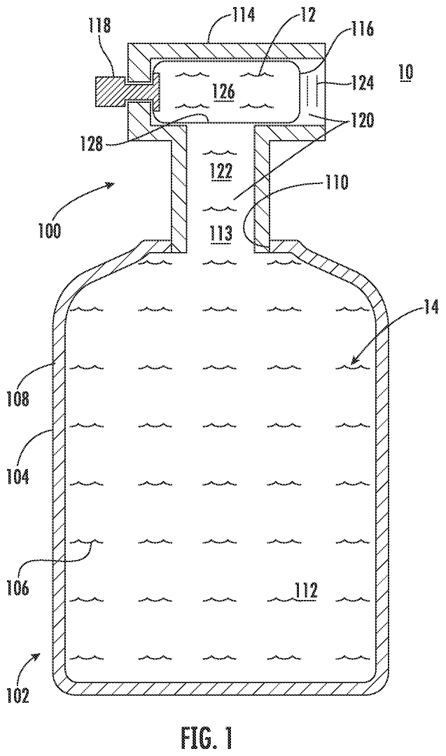

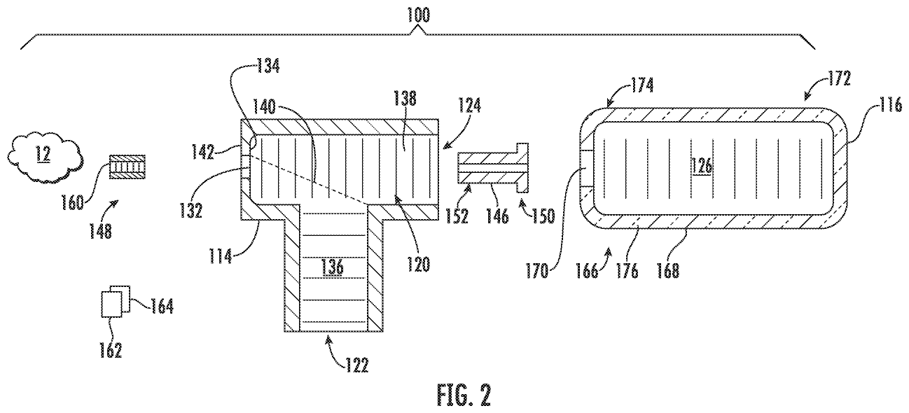

Reference will now be made to the drawings wherein like reference numerals identify similar structural features or aspects of the subject disclosure. For purposes of explanation and illustration, and not limitation, a partial view of an exemplary embodiment of a discharge valve constructed in accordance with the disclosure is shown in FIG. 1 and is designated generally by reference character 100. Other embodiments of discharge valves, pressure vessel assemblies, and methods of making pressure vessel assemblies in accordance with the present disclosure, or aspects thereof, are provided in FIGS. 2-7, as will be described. The systems and methods described herein can be used for storing pressurized fire suppressant, such as in fire extinguisher assemblies, though the present disclosure is not limited to fire extinguisher assemblies or to discharge valves in general.

Referring to FIG. 1, a pressure vessel assembly 102, e.g., a fire extinguisher assembly, is shown. The pressure vessel assembly 102 includes the discharge valve 100, a pressure vessel 104, and a compressed fluid 106. The pressure vessel 104 has a wall 108 and a boss 110. The wall 108 separates a chamber 112 defined within the pressure vessel 104 from the external environment 10. The boss 110 extends from an end of the pressure vessel and defines a port 113. The port 113 is in fluid communication with the chamber 112 of the pressure vessel 104. The discharge valve 100 is fixed to the pressure vessel 104 by the boss 110 and fluidly couples the chamber 112 of the pressure vessel 104 to the external environment 10. The compressed fluid 106 is impounded within the chamber 112 of the pressure vessel 104 and is separated from the external environment 10 by the discharge valve 100. In certain embodiments the compressed fluid 106 can include an expellant and suppressant mixture suppressant 14, such as “wet-chemical” systems, e.g., employing a liquid agent like potassium carbonate salt solutions pressurized with a nitrogen expellant, and liquid systems utilizing “clean agents” or inert gases.

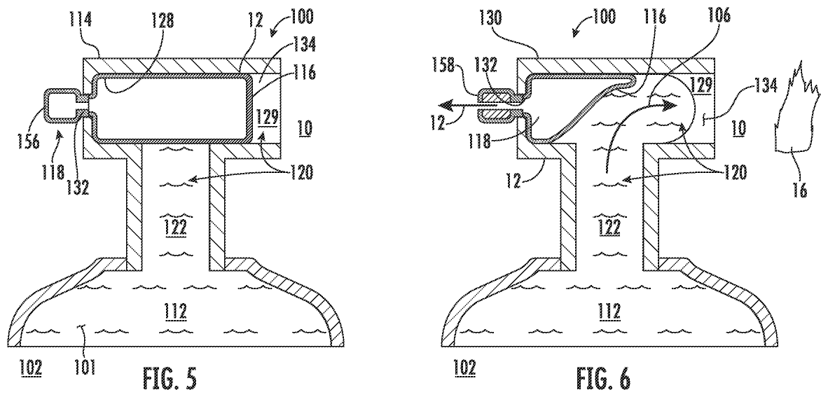

The discharge valve 100 includes a valve body 114, a non-rigid valve member 116, and a closure 118. The valve body 114 defines a bore 120 that extends between an inlet 122 and an outlet 124. The non-rigid valve member 116 has an interior 126 that is variable between a first volume 128 (shown in FIG. 5) and a second volume 130 (shown in FIG. 6), the non-rigid valve member 116 fixed within the bore 120 between the inlet 122 and the outlet 124 of the valve body 114. The closure 118 is seated to the valve body 114 and extends to the non-rigid valve member 116 for communicating an inflation fluid 12 between the non-rigid valve member 116 and the external environment 10.

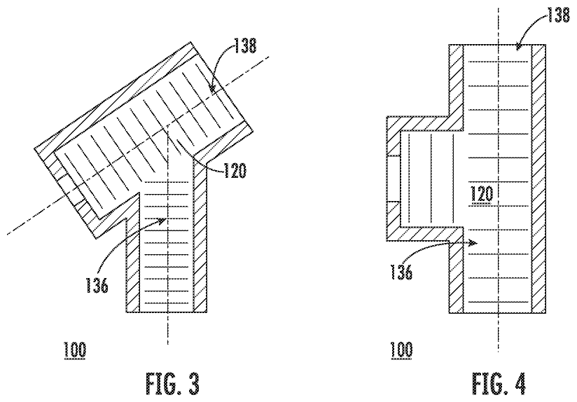

With reference to FIG. 2, the discharge valve 100 is shown in an exploded view. The valve body 114 is arranged for fixation to the boss 110 (shown in FIG. 1) of the pressure vessel 104 (shown in FIG. 1), e.g., with threads, and defines therethrough the bore 120 and a channel 132. The bore 120 is bounded by an interior surface 134 of the valve body 114 and has an inlet segment 136 and an outlet segment 138. The inlet segment 136 extends between the inlet 122 and the outlet segment 138. The outlet segment 138 extends between the inlet segment 136 and the outlet 124. The channel 132 is defined by the valve body 114. More specifically, the channel 132 defined by the valve body 114 extends between the exterior surface 142 and the interior surface 134 of the bore 120. As also shown in FIG. 2 the outlet segment 138 is substantially orthogonal to the inlet segment 136. In certain embodiments, the outlet segment 138 can be oblique relative to the inlet segment 136 of the bore 120, as shown in FIG. 3. In accordance with certain embodiments, the outlet segment 138 can be coaxial to the inlet segment 136 of the bore 120, as shown in FIG. 4.

With continuing reference to FIG. 2, the closure 118 (shown in FIG. 1) is an assembly including a tube member 146 and seal member 148. The tube member 146 is configured to be slidably received in the channel 132 and in communication with the interior 126 of the non-rigid valve member 116, the interior 126 being hollow. More specifically, the tube member 146 is configured for conveying the inflation gas 12 between the non-rigid valve member 116 and the external environment 10. As shown in FIG. 2, the tube member 146 has a flange portion 150 and a threaded portion 152. The threaded portion 152 and the flange portion 150 are arranged on longitudinally opposite ends of the tube member 146. The flange portion 150 is configured to receive thereon a portion of the non-rigid valve member 116 for compression against the interior surface 134 of the valve body 114. The threaded portion 152 is configured to receive thereon the seal element 148, e.g., a fastener, for fixation of the tube member 146 against the exterior surface 142 of the valve body 114.

The seal element 148 is arranged to selectively communicate the inflation gas 12 with the external environment 10. In this respect the seal element 148 has a closed position 156 (shown in FIG. 5), wherein the seal element 148 impounds the inflation gas 12 within the non-rigid valve member 116, and an open position 158 (shown in FIG. 6), wherein the interior 126 of the non-rigid valve member 116 is in fluid communication with the external environment 10. In certain embodiments the seal element 148 includes a frangible member 160. In accordance with certain embodiment the seal element 148 can include a manually-actuated valve 162. It is also contemplated that the seal element 148 can include an electrically-actuated valve 164, such as a solenoid valve.

The non-rigid valve member 116 includes a resilient body 166 having a wall 168, an aperture 170, a free end 172, and fixed end 174. The wall 168 is formed from an elastomeric material 176, such as rubber, and is configured to conform to the interior surface 134 of the bore 120. The aperture 170 is sized to receive therethrough the tube member 146 such that the tube member 146 can fix a portion of the resilient body 166 bounding the aperture 170 against the interior surface 134 of the bore 120. The fixed end 174 is fixed to the interior surface 134 of the bore 120 by the closure 118. The free end 172 of the non-rigid valve member 116 extends from the fixed end 174 and in the direction of the outlet 124 of the valve body 114. It is contemplated that the resilient body 166 allow the interior 126 of the non-rigid valve member 116 to expand and contract between the first volume 128 (shown in FIG. 5) and the second volume 130 (shown in FIG. 6). The first volume 128 is greater than the second volume 130, the non-rigid valve member 116 thereby selectively placing the chamber 112 of the pressure vessel 104 in fluid communication with the external environment 10 through the discharge valve 100 when non-rigid valve member 116 defines the first volume 128.

The inflation gas 12 is impounded within the non-rigid valve member 116 and has a mass selected to seal the bore 120. In certain embodiments the inflation gas 12 includes nitrogen, e.g., compressed air. In accordance with certain embodiments the inflation gas 12 includes an inert gas, e.g., substantially pure nitrogen and/or argon. It is also contemplated that the inflation gas 12 can include an expellant and fire suppressant mixture, e.g., the expellant and fire suppressant mixture 14 (shown in FIG. 5). As will be appreciated by those of skill in the art, embodiments employing an inflation gas sharing the composition of the expellant and fire suppressant mixture contained, e.g., retained or impounded, within the chamber 112 (shown in FIG. 1) of the pressure vessel 104 (shown in FIG. 1) can simplify the manufacture of the pressure vessel assembly 102 (shown in FIG. 1) and/or improve the performance of the pressure vessel assembly 102.

With reference to FIGS. 5 and 6, the non-rigid valve member 116 is shown having the first volume 128 and the second volume 130, respectively. As shown in FIG. 5, when the non-rigid valve member 116 has (defines) the first volume 128 the non-rigid valve member 116 fluidly separates the inlet 122 of the valve body 114 from the outlet 124 of the valve body 114. Fluid separation of the inlet 122 from the outlet 124 fluidly isolates the chamber 112 of the pressure vessel 104 from the external environment 10. It is contemplated that the non-rigid valve member 116 maintain the first volume 128 by impounding therein the inflation gas 12, the inflation gas 12 conforming the wall of the resilient body 166 to the interior surface 134 of the bore 120 valve body 114. Notably, the inflation gas 12 drives an end of the resilient body 166 towards the outlet 124 of the valve body 114 and is impounded therein by the closure 118 while in the closed position 156.

As shown in FIG. 6, when the non-rigid valve member 116 has the second volume 130 the inlet 122 of the valve body 114 is in fluid communication with the outlet 124 of the valve body 114. Fluid communication between the inlet 122 and the outlet 124 of the valve body 114 allows the compressed fluid 106 contained within the chamber 112 of the pressure vessel 104 to issue from the outlet 124 to the external environment 10, e.g., to suppress a flame 16. It is contemplated that the non-rigid valve member 116 change from the first volume 128 (shown in FIG. 6) to the second volume 130 by the closure 118 moving to the open position 158, the inflation gas 12 thereby being forced from the non-rigid valve member 116 through the channel 132, and the resilient body 166 thereby abutting only a portion of the interior surface 134 of the bore 120. The closure 118 can move between the closed position 156 (shown in FIG. 5) and the open position 158 by fracture of the frangible member 160 (shown in FIG. 2), actuation of the manually-actuated valve 162 (shown in FIG. 2), or actuation of the electrically-actuated valve 164 (shown in FIG. 2).

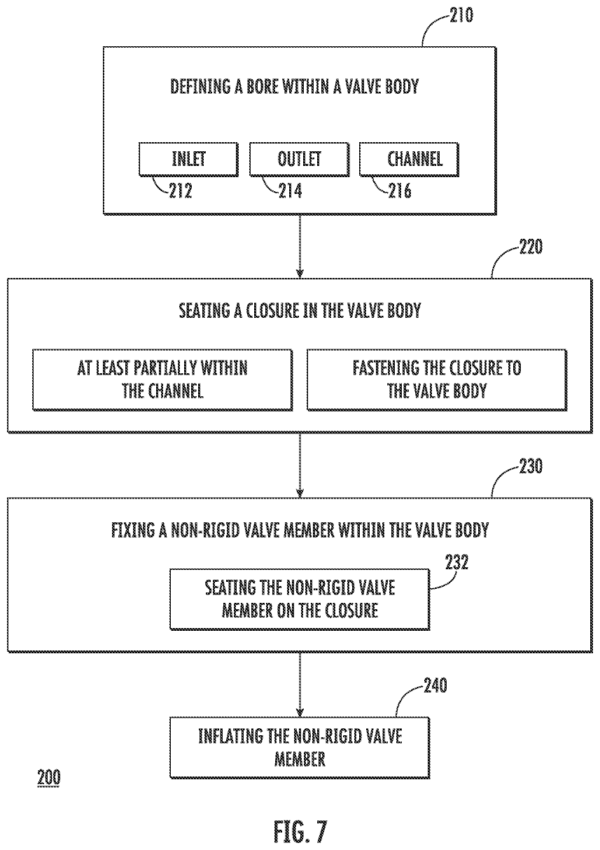

With reference to FIG. 7, a method 200 of making a discharge valve for a pressure vessel assembly, e.g., the discharge valve 100 (shown in FIG. 1) for the pressure vessel assembly 102 (shown in FIG. 1), is shown. As shown with box 210, the method 200 includes defining a bore within a valve body, e.g., the bore 120 within the valve body 114. More specifically, the bore can extend between an inlet and an outlet of the valve body, e.g., the inlet 122 (shown in FIG. 1) and the outlet 124 (shown in FIG. 1), and a channel, e.g., the channel 132 (shown in FIG. 2), further defined within the bore and in communication with the bore, as shown with boxes 212-216.

As shown with box 220, the method 200 also includes seating a closure, e.g., the closure 118 (shown in FIG. 1), in the valve body 114. For example, seating the closure on the valve body can include slidably receiving the closure at least partially within a channel defined within the valve body and extending between the exterior surface of the valve body and the bore, e.g. the channel 132 (shown in FIG. 2), as shown with box 222. The closure can thereafter be fastened to the valve body with a seal element, e.g., the seal element 148 (shown in FIG. 2), as shown with box 224.

As shown with box 230, the method 200 additionally includes fixing a non-rigid valve member, e.g., the non-rigid valve member 116 (shown in FIG. 1) within the bore between the inlet of the valve body and the outlet of the valve body. Seating the closure to the valve body can include placing an interior of non-rigid valve member, e.g., the interior 126, in fluid communication with the closure, as shown with box 232. The non-rigid valve member can thereafter be inflated to a first volume, e.g., the first volume 128 (shown in FIG. 5), such that the non-rigid valve member occludes the bore, as shown with box 240. In certain embodiments the non-rigid valve member can be inflated using air, e.g., air 18 (shown in FIG. 5), as shown with box 242. In accordance with certain embodiments the non-rigid valve member can be inflated using an inert gas, an inert gas 20 (shown in FIG. 5), as shown with box 244. It is also contemplated that the non-rigid valve member can be inflated with a fire suppressant, e.g., the fire suppressant 14 (shown in FIG. 5), as shown with box 246.

Compressed fluid discharge in pressure vessel assemblies can be controlled using a valve body housing a rigid plunger structure or piston structure. Plunger structures generally require force enough to overcome the pressure of the compressed fluid contained within the pressure vessel, which resists opening of the valve. Piston structures can require less pressure to open as the pressure exerted on the piston structure vents as the piston structure initially moves from the valve seat. Relatively tight tolerances are typically required to provide good sealing and free motion of rigid plunger structures and piston structures. In some valves the rigid plunger structure or piston structure remains within the flow path of the compressed fluid subsequent to actuation, limiting flow rate through the valve.

In embodiments described herein discharge valves employ non-rigid valve members. The non-rigid valve members occlude the bore extending through the valve body when pressurized, the pressurized non-rigid valve member conforming to the interior surfaces and contours within the valve body. Upon actuation the non-rigid valve member contracts, the valve member thereby allowing fluid flow through the valve body. Notably, when pressurized, the non-rigid valve member conforms to the contour of interior of the valve body, the non-rigid valve member thereby accommodating dimensional variation peculiar to the specific valve body. Further, the contraction of the non-rigid valve member upon actuation limits the obstruction that the valve member presents to compressed fluid issuing from the discharge valve upon actuation, allowing the flow area of the discharge valve to be relatively large relative to the size of the valve body.

The term “about” is intended to include the degree of error associated with measurement of the quantity based upon the equipment available at the time of filing the application.

The terminology used herein is for the purpose of describing embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a situation or material to the teachings of the present disclosure without departing from the essential scope thereof. Therefore, it is intended that the present disclosure not be limited to the embodiment disclosed as the best mode contemplated for carrying out this present disclosure, but that the present disclosure will include all embodiments falling within the scope of the claims.

What is claimed is:

1. A discharge valve, comprising:
a valve body with a bore extending between an inlet and an outlet;
a closure seated to the valve body and extending to the bore; and
a non-rigid valve member with an interior and fixed within the bore between the inlet and the outlet of the valve body, wherein the interior of the non-rigid valve member is in fluid communication with the closure for expansion and contraction of the non-rigid valve member.

2. The discharge valve of claim 1, wherein the bore has an inlet segment and an outlet segment, the inlet segment of the bore joining the outlet segment of the bore at an intersection within the valve body.

3. The discharge valve of claim 2, wherein the outlet segment of the bore is orthogonal relative to the inlet segment of the bore.

4. The discharge valve of claim 2, wherein the outlet segment of the bore is oblique relative to the inlet segment of the bore.

5. The discharge valve of claim 2, wherein the outlet segment of the bore is coaxial relative to the inlet segment of the bore.

6. The discharge valve of claim 2, wherein the closure extends in coaxial with the outlet segment of the bore, wherein the closure is orthogonal or oblique relative to the inlet segment of the bore.

7. The discharge valve of claim 1, wherein the non-rigid valve member is formed from an elastomeric material.

8. The discharge valve of claim 1, wherein the non-rigid valve member has a fixed end and a free end, the fixed end fixed to an interior surface of the bore by the closure, the free end arranged between the closure and the outlet of the bore.

9. The discharge valve of claim 1, wherein the valve body defines a channel extending between an exterior surface of the valve body and an interior surface of the bore.

10. The discharge valve of claim 1, wherein the closure includes a tube member having a threaded portion and a longitudinally opposite flange portion, the flange portion compressing a portion of the valve member against an interior surface of the bore, the threaded portion extending beyond an exterior surface of the valve body and receiving thereon a seal element.

11. The discharge valve of claim 1, wherein the closure includes a frangible member, a manually-actuated valve, or an electrically actuated valve.

12. The discharge valve of claim 1, further comprising an inflation gas impounded within the non-rigid valve member.

13. The discharge valve of claim 1, wherein the non-rigid valve member has first volume and a second volume, the first volume greater than the second volume, the first volume occluding the bore and fluidly separating the inlet from the outlet of the valve body, the second volume not occluding the bore, the inlet in fluid communication with the outlet of the valve body.

14. A fire extinguisher assembly, comprising:
a pressure vessel with a boss, the pressure vessel having a chamber and the boss defining a port in communication with the chamber;
a discharge valve as recited in claim 1 fixed to the boss, wherein the inlet of the valve body is in fluid communication with the chamber through the port defined by the boss; and
a fire suppressant contained within the chamber of the pressure vessel, wherein the non-rigid valve member occludes the bore such that fire suppressant is retained within the chamber.

15. The fire extinguisher assembly of claim 14, wherein the non-rigid valve member is formed from an elastomeric material, and wherein the non-rigid valve member has a fixed end and a free end, the fixed end fixed to an interior surface of the bore by the closure, the free end arranged between the closure and the outlet of the bore.

16. The fire extinguisher assembly of claim 14, wherein the valve body defines a channel extending between an exterior surface of the valve body and an interior surface of the bore, and wherein the closure includes a tube member having a threaded portion and a longitudinally opposite flange portion, the flange portion compressing a portion of the valve member against an interior surface of the bore, the threaded portion extending beyond an exterior surface of the valve body and receiving thereon a seal element.

17. The fire extinguisher assembly of claim 14, further comprising an inflation gas including air impounded within the non-rigid valve member.

18. The fire extinguisher assembly of claim 14, further comprising an inert inflation gas impounded within the non-rigid valve member.

19. The fire extinguisher assembly of claim 14, further comprising an inflation gas impounded within the non-rigid valve member, wherein the inflation gas includes additional fire suppressant.

20. A method of making a discharge valve, comprising:
defining a bore extending between an inlet and an outlet in a valve body;
seating a closure within the valve body such that the closure extends at least partially within the bore of the valve body; and
fixing a non-rigid valve member with an interior within the bore between the inlet of the valve body and the outlet of the valve body, wherein the seating the closure to the valve body includes placing the interior of non-rigid valve member in fluid communication with the closure.
